(19) United States
(12) Patent Application Publication
(10) Pub. No.: US 2025/0276334 A1
(43) Pub. Date: Sep. 4, 2025

(54) LOW WATER CONSUMPTION SHOWERHEAD

(71) Applicant: Kohler Co., Kohler, WI (US)

(72) Inventors: Prasanth Jayakumar, Maharashtra (IN); Jason Kwacz, Kohler, WI (US); Shaun Skelton, Sun Prairie, WI (US); Robin Whitfield, Cheltenham (GB)

(21) Appl. No.: 19/049,239

(22) Filed: Feb. 10, 2025

Related U.S. Application Data
(60) Provisional application No. 63/559,322, filed on Feb. 29, 2024.

(51) Int. Cl. B05B 1/18; B05B 1/02

(52) U.S. Cl. CPC B05B 1/185; B05B 1/02

(57) ABSTRACT

A low water consumption showerhead may provide users with the experience of higher water pressure without necessarily requiring an increased supply of water. A first example showerhead may include nozzles having coaxial inner and outer chambers, each of which may provide a user with one or more different types of media. The inner chamber of the nozzle may be adjustable with respect to the outer chamber, which may allow a user to manipulate the relative rate of flow from both chambers. A second example showerhead may include a spiral channel along which one or more types of media may flow. Outlets may be positioned along the spiral channel such that a portion of the media within the spiral channel may exit the showerhead and be directed to a user. The width or area of the spiral channel may taper such that substantially consistent pressure may be provided at each outlet.

### CROSS-REFERENCED TO RELATED APPLICATIONS

The present application claims priority to and the benefit of U.S. Provisional Patent Application No. 63/559,322, filed Feb. 29, 2024, entitled “LOW WATER CONSUMPTION SHOWERHEAD,” the entirety of which is hereby incorporated by reference.

### BACKGROUND

Providing higher water pressure to showerheads traditionally involves supplying a higher volume of water. Therefore, high water pressure can result in higher utility payments, greater water usage and/or waste, and other undesirable outcomes. Accordingly, there is a need for a showerhead that provides increased water pressure without a higher volume of water.

### BRIEF DESCRIPTION OF DRAWINGS

FIG. 1 is a bottom perspective view of an example showerhead.

FIG. 2 is a side cross-sectional view of an example showerhead.

FIG. 3 is a side cross-sectional view of an example nozzle.

FIG. 4 is a bottom plan view of an example nozzle.

FIG. 5 is a side cross-sectional view of an example adjustable nozzle in a first position.

FIG. 6 is a side cross-sectional view of an example adjustable nozzle in a second position.

FIG. 7 is a bottom plan view of an example adjustable nozzle.

FIG. 8 is a bottom perspective view of an example showerhead.

FIG. 9 is a top perspective view of an example showerhead.

FIG. 10 is a bottom cross-sectional view of an example showerhead.

FIG. 11 is a side cross-sectional view of an example heated conduit.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

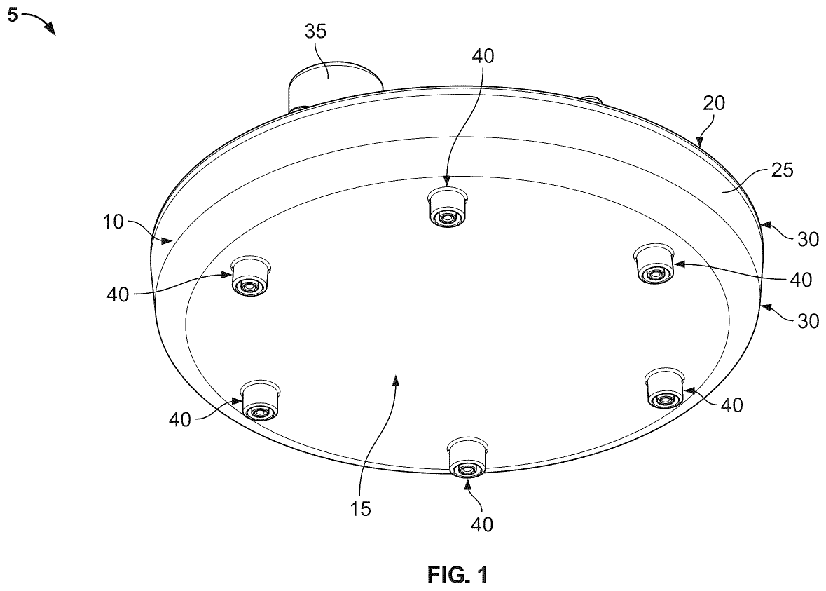

Referring first to FIG. 1, an example showerhead 5 may have a body 10 defined by a faceplate 15 and a backplate 20, which may oppose the faceplate 15. When the showerhead 5 is in use by a user, the faceplate 15 may face in the direction of the user and the backplate 20 may face away from the user. A sidewall 25 may extend between outer boundaries 30 of the faceplate 15 and backplate 20. The faceplate 15 and backplate 20 may each be substantially circular in shape, and the sidewall 25 may thus have a generally circular profile. Although illustrated as circular in FIG. 1, the faceplate 15, backplate 20, and sidewall 25 may be provided in different shapes and sizes.

A primary inlet 35 may receive, be received by, or otherwise be coupled to an external source of media (not shown) to allow a first type of media from the external source to enter the body 10 of the showerhead 5. For example, the first type of media may be water, air, heated air, compressed air, hydrogen, ozone, essential oils, scented fluids, shampoo, conditioner, or any other fluid or gas. The external source may be, for example, a water pipe of a residential building. The primary inlet 35 may be coupled to or integrally formed with the backplate 20. The primary inlet 35 may extend upwardly from the backplate 20, or the primary inlet 35 may be positioned in any suitable manner.

One or more nozzles 40 may be in fluid communication with the primary inlet 35 such that the media that enters the showerhead 5 via the primary inlet 35 can exit the showerhead 5 via one or more of the nozzles 40. The one or more nozzles 40 may be coupled to and extend downwardly from the faceplate 15, and the one or more nozzles 40 may be provided in the form of openings positioned on the faceplate 15 or in other forms now known or hereafter developed. In the example of FIG. 1, the showerhead 5 includes six nozzles 40 disposed proximate to the outer boundary 30 of the faceplate 15 and evenly spaced radially apart from one another. However, the showerhead 5 may include any number of nozzles 40 which may be positioned in any suitable arrangement.

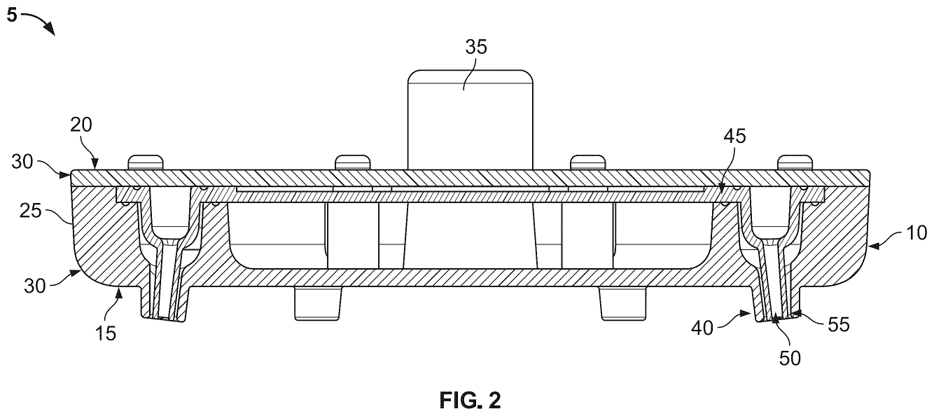

Turning to FIG. 2, the showerhead 5 may include one or more secondary inlets (not shown) in addition to or in place of the primary inlet 35. The one or more secondary inlets may receive, be received by, or otherwise be coupled to an external source of media (not shown) to allow a second type of media from the external source to enter the showerhead 5. For example, the second type of media may be water, air, heated air, compressed air, hydrogen, ozone, essential oils, scented fluids, shampoo, conditioner, or any other fluid or gas. The external source that feeds the one or more secondary inlets may be the same external source or a different external source than the external source that feeds the primary inlet 35. The first type of media that enters the body 10 via the primary inlet 35 may be the same type of media or a different type of media than the second type of media that enters the body 10 via the one or more secondary inlets. As one example, water may enter the body 10 of the showerhead 5 via the primary inlet 35 and air may enter the body 10 via the one or more secondary inlets. As another example, water may enter the body 10 via both the primary inlet 35 and the one or more secondary inlets. Alternatively, the showerhead 5 may have any other suitable configuration.

A partition 45 may be positioned within the showerhead 5 to separate the first and second type of media within the body 10. The partition 45 may be disposed within the body 10, and at least a portion of the partition 45 may extend into and occupy at least a portion of at least one nozzle 40. The partition 45 may divide at least one nozzle 40 into two distinct portions-a first chamber 50, which may be an inner chamber, and a second chamber 55, which may be an outer chamber-that are not in fluid communication with one another. The second chamber 55 may at least partially surround the first chamber 50. Thus, the partition 45 may prevent the first and second type of media that enter the showerhead 5 from mixing until they exit the showerhead 5 via one or more nozzles 40. The partition 45 may at least partially extend into each nozzle 40 such that each nozzle 40 is divided into the first chamber 50 and the second chamber 55.

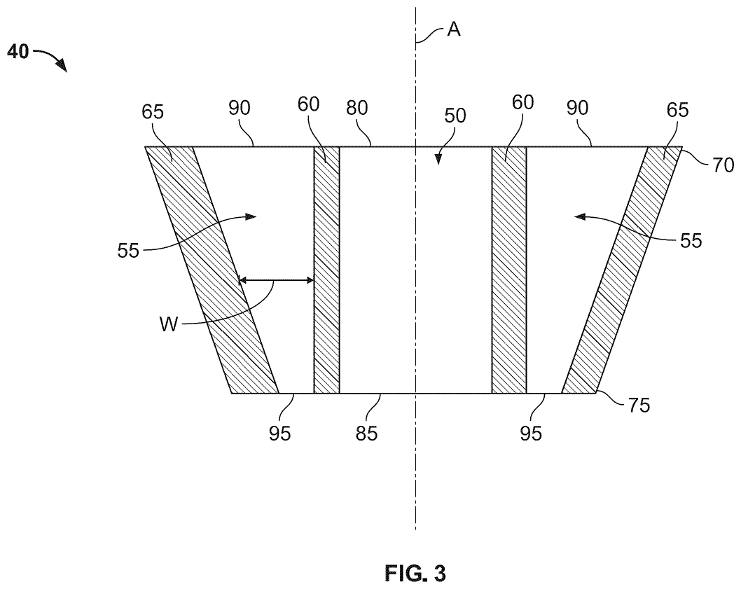

Turning to FIG. 3, a portion of the partition 45 that extends into the nozzle 40 may form a first housing 60. The nozzle 40 may include the first chamber 50. The first chamber 50 may be defined by the first housing 60. The nozzle 40 may include the second chamber 55. The second chamber 55 may be defined by the space between the first housing 60 and a second housing 65. The overall shape of the nozzle 40, which may be defined by the second housing 65, may be substantially conical or frustoconical or may have another shape. The shape of the first chamber 50, which may be defined by the first housing 60, may be substantially cylindrical or may have another shape.

The first and second housings 60, 65 may be positioned along a central longitudinal axis A of the nozzle 40. The first housing 60 and the second housing 65 may be angled with respect to the axis A, or may be substantially parallel to the axis A. For example, in the configuration of FIG. 3, the distance between the second housing 65 and the axis A (which may be measured in a direction substantially perpendicular to the axis A) may be greater at a first end 70 of the nozzle 40 than it is at a second end 75 of the nozzle 40. As such, a width W of the second chamber 55, which may be associated with the distance between the first housing 60 and the second housing 65, may taper from a first width at the first end 70 to a second width at the second end 75. The first width of the second chamber 55 at the first end 70 may be greater than the second width of the second chamber 55 at the second end 75. Alternatively, the first housing 60 and the second housing 65 may each be oriented differently with respect to the axis A. For example, the first housing 60 and second housing 65 may each be oriented substantially parallel to the axis A, or may each be oriented at a same or different angle with respect to the axis A. The first housing 60 and second housing 65 may be oriented in any suitable configuration which may be selected to achieve a particular result.

The first chamber 50 may include a first inlet 80. The first inlet 80 may form an opening between the first chamber 50 and the body 10 of the showerhead 5 at the first end 70 of the nozzle 40. The first inlet 80 may allow media that enters the body 10 to travel to the first chamber 50. The first chamber 50 may include a first outlet 85. The first outlet 85 may form an opening of the first chamber 50 to the external environment to allow media that enters the first chamber 50 to exit the showerhead 5 at the second end 75 of the nozzle 40.

Likewise, the second chamber 55 may include a second inlet 90. The second inlet 90 may form an opening between the second chamber 55 and the body 10 of the showerhead 5 at the first end 70 of the nozzle 40. The second inlet 90 may allow media that enters the body 10 to travel to the second chamber 55. The second chamber 55 may include a second outlet 95. The second outlet 95 may form an opening of the second chamber 55 to the external environment to allow media that enters the second chamber 55 to exit the showerhead 5 at the second end 75 of the nozzle 40.

The first chamber 50 and second chamber 55 may receive media from one or more external sources via the first inlet 80 and second inlet 90, respectively. The first chamber 50 and second chamber 55 may direct such media out of the showerhead 5 and toward a user via the first outlet 85 and second outlet 95, respectively. The first outlet 85 and second outlet 95 may expel different types of media or the same type of media. For example, the first outlet 85 may expel media that enters the body 10 via the one or more secondary inlets, whereas the second outlet 95 may expel media that enters the body 10 via the primary inlet 35. Alternatively, the first outlet 85 and second outlet 95 may each expel media that enters the body 10 via the primary inlet 35 or may be configured in any other suitable arrangement. When the showerhead 5 is in use, media may be provided to a user via only the first outlet 85, only the second outlet 95, or both the first outlet 85 and second outlet 95 simultaneously.

As a non-limiting example, air may flow from an external source into the body 10 of the showerhead 5 via the one or more secondary inlets. Such air may enter the first chamber 50 of the nozzle 40 via the first inlet 80 and may exit the nozzle 40 via the first outlet 85. At the same time, water may flow from an external source into the body 10 of the showerhead 5 via the primary inlet 35. Such water may enter the second chamber 55 of the nozzle 40 via the second inlet 90 and may exit the nozzle 40 via the second outlet 95. In this example, the first housing 60 may keep the air and water separated within the nozzle 40, but the air and water may mix or blend to form a unitary stream after exiting the nozzle 40. Such mixing or blending may occur before the media comes into contact with a user. In this example, the air may increase the force of the stream flowing from each nozzle 40 such that a user may perceive the sensation of a stream with higher water pressure without increasing the volume of water supplied to the showerhead 5. Thus, the addition of air or another non-water media to the stream provided by the nozzle 40 may enable a user to reduce water usage without sacrificing the quality of the experience of using the showerhead 5.

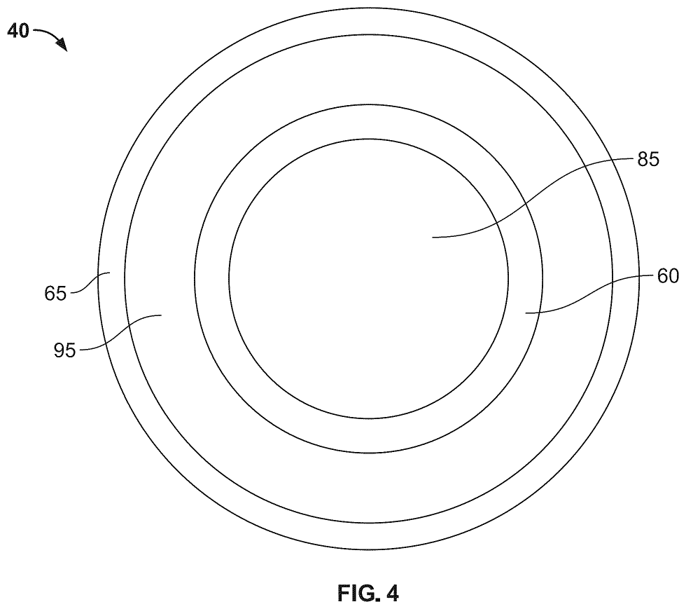

As illustrated in FIG. 4—a bottom plan view of the nozzle 40—the first outlet 85 may be substantially circular in shape and the second outlet 95 may be substantially annular in shape. As such, both the first housing 60 and the second housing 65 may be provided in the form of an annular cylinder. Thus, in the illustrated example, the first outlet 85, first housing 60, second outlet 95, and second housing 65 may all have substantially circular profiles when viewed from below. However, other shapes are envisioned for the first outlet 85, first housing 60, second outlet 95, and second housing 65, and each of the foregoing may be any suitable shape or size.

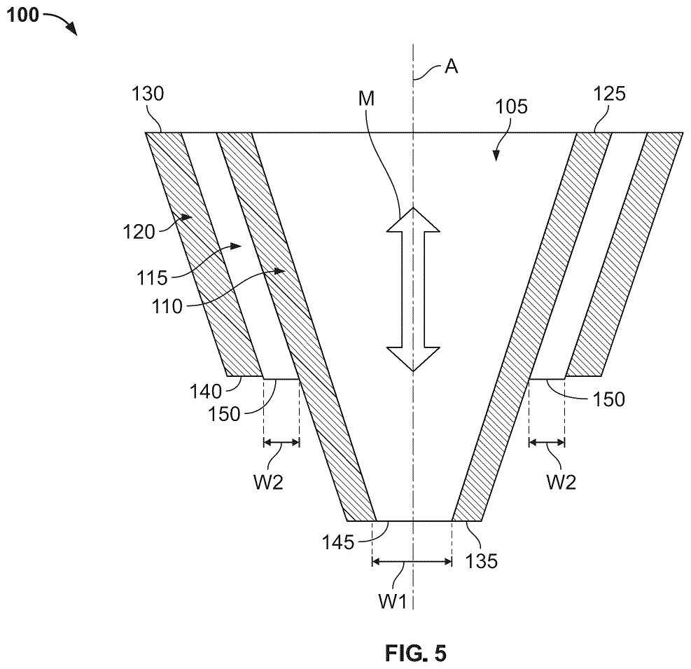

Turning to FIG. 5, a nozzle 100 may be constructed so that a portion of the nozzle 100 may be adjustable by translation in a linear direction such that the flow of a first and second type of media from the nozzle 100 may be varied. The nozzle 100 may be constructed similarly to the nozzle 40 as described above. The nozzle 100 may include a first chamber 105 and a second chamber 115. The first chamber 105 may be adjustable and may be defined by a first housing 110. The second chamber 115 may be defined by a second housing 120. The first chamber 105 may be an inner chamber and the second chamber 115 may be an outer chamber.

The first chamber 105 of the nozzle 100 may be movable between a first position and a second position. The direction of movement of the first chamber 105, which may follow a path along arrow M, may be substantially parallel with an axis A. Thus, the first chamber 105 may be adjustable relative to the second chamber 115 of the nozzle 100. When the first chamber 105 is in the first position, as one example and as illustrated in FIG. 5, a first end 125 of the first housing 110 may be proximate to or substantially coplanar with a first end 130 of the second housing 120, while a second end 135 of the first housing 110 may extend beyond a second end 140 of the second housing 120.

A first outlet 145 may form an opening of the first chamber 105 to the external environment, and a second outlet 150 may form an opening of the second chamber 115 to the external environment. A width W1 of the first outlet 145 may be fixed, while a width W2 of the second outlet 150 may vary depending on the position of the first chamber 105 with respect to the second housing 120. As the first chamber 105 moves between the first and second positions, the distance between the first housing 110 and the second housing 120 may change, thereby changing the width W2 of the second outlet 150. Therefore, a user may manipulate the volume of the second chamber 115 and the width W2 of the second outlet 150 by adjusting the position of the first chamber 105 with respect to the second housing 120. By doing so, a user may manipulate the rate of flow of media from the second outlet 150, and as a result, the user may manipulate the ratio of the rate of flow of media from the second outlet 150 relative to the rate of flow of media from the first outlet 145.

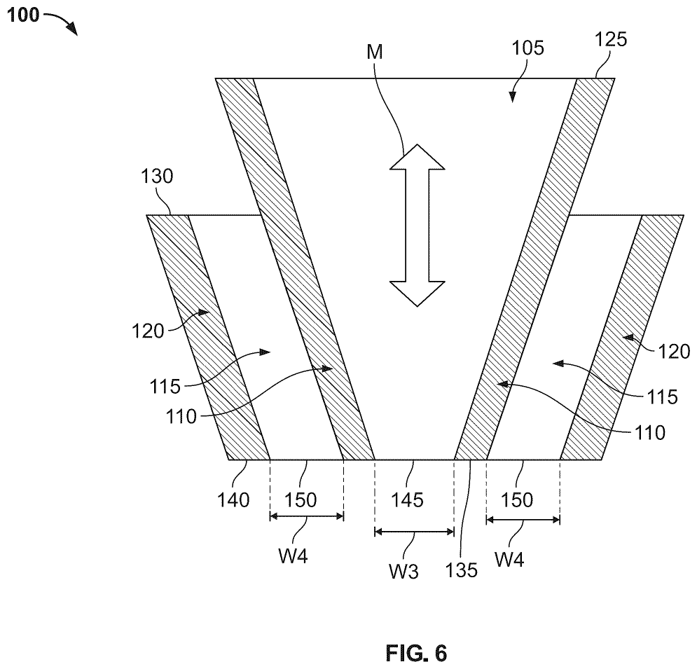

As illustrated in FIG. 6, the first chamber 105, defined by the first housing 110, of the nozzle 100 may occupy a second position with respect to the second housing 120. With the first chamber 105 in the second position, the second end 135 of the first housing 110 may be proximate to or substantially coplanar with the second end 140 of the second housing 120, while the first end 125 of the first housing 110 may extend beyond the first end 130 of the second housing 120. In this configuration, the first outlet 145 may have a width W3 and the second outlet 150 may have a width W4. The width W3 may be the same as the width W1 of FIG. 5, whereas the width W4 may be greater than the width W2 of FIG. 5. Accordingly, the volume of the second chamber 115 when the first chamber 105 is in the second position may be greater than the volume of the second chamber 115 when the first chamber 105 is in the first position. The second chamber 115 may be adjustable relative to the first chamber 105 in the same manner as described herein with reference to the first chamber 105 being adjustable relative to the second chamber 115.

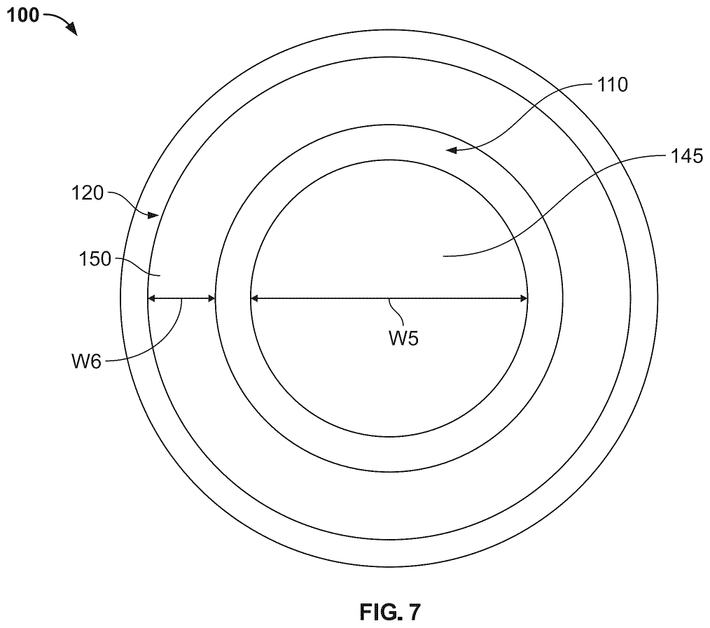

Turning to the bottom plan view of the nozzle 100 provided in FIG. 7, the first outlet 145 may be substantially circular in shape and the second outlet 150 may be substantially annular in shape. As such, both the first housing 110 and the second housing 120 may be provided in the form of an annular cylinder. Thus, in the illustrated example, the first outlet 145, first housing 110, second outlet 150, and second housing 120 may all have substantially circular profiles when viewed from below. However, other shapes are envisioned for the first outlet 145, first housing 110, second outlet 150, and second housing 120, and each of the foregoing may be any suitable shape or size.

The configuration illustrated in FIG. 7 may correspond to the first position or the second position of the first chamber 105, as illustrated in FIG. 5 and FIG. 6, respectively. The width W5 of the first outlet 145 may be fixed, whereas the width W6 of the second outlet 150 may vary according to the position of the first chamber 105 with respect to the second housing 120. As one example, the widths W5, W6 may correspond to the widths W1, W2 of FIG. 5, respectively. As another example, the widths W5, W6 may correspond to the widths W3, W4 of FIG. 6, respectively. Alternatively, other widths may correspond to the widths W5, W6 depending on the positioning of the first chamber 105. As the first chamber 105 moves between the first and second position, the width W6 and the ratio between the rate of flow of media from the first outlet 145 and the rate of flow of media from the second outlet 150 may vary.

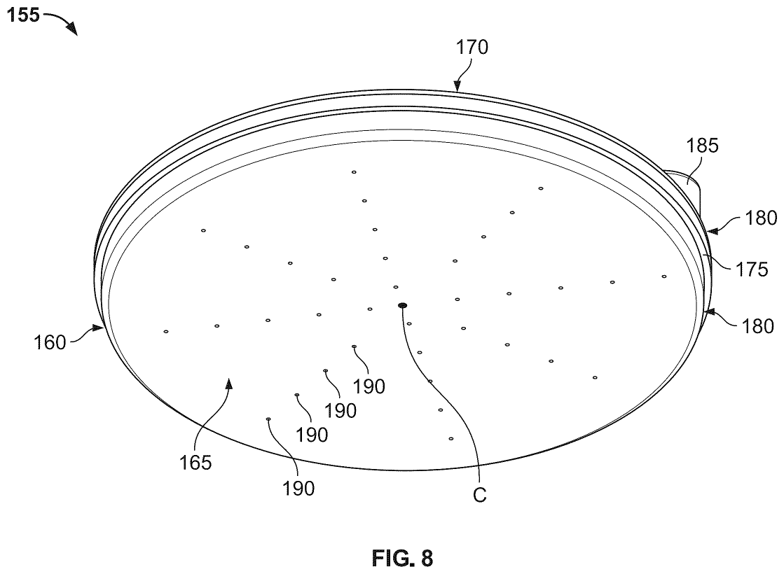

Turning to FIG. 8, a second example showerhead 155 may have a body 160 defined by a faceplate 165, which may have a center point C, and a backplate 170 which may oppose the faceplate 165. A sidewall 175 may extend between outer boundaries 180 of the faceplate 165 and the backplate 170. The faceplate 165 and backplate 170 may each be substantially circular in shape, and the sidewall 175 may thus have a generally circular profile. Although illustrated as circular in FIG. 1, the faceplate 165, backplate 170, and sidewall 175 may be provided in different shapes. The showerhead 155 may be constructed such that, when the showerhead 155 is in use by a user, the faceplate 165 faces in the direction of the user while the backplate 170 faces away from the user.

One or more inlets 185 may receive, be received by, or otherwise be coupled to an external source of media (not shown) and allow media from the external source to enter the body 160 of the showerhead 155. For example, the media may be water, air, heated air, compressed air, hydrogen, ozone, essential oils, scented fluids, shampoo, conditioner, or any other fluid or gas. The external source may be, for example, a water pipe of a residential building. The one or more inlets 185 may be coupled to or formed integrally with the backplate 170. The one or more inlets 185 may extend upwardly from the backplate 170, or the one or more inlets 185 may be positioned in any suitable manner.

The showerhead 155 may include a plurality of outlets 190 arranged on the faceplate 165. Each of the plurality of outlets 190 may be in fluid communication with one or more inlets 185 such that the one or more inlets 185 may provide media to the plurality of outlets 190. Each of the plurality of outlets 190 may form an opening in the faceplate 165 through which media that enters the body 160 of the showerhead 155 via one or more inlets 185 may exit the showerhead 155 to the external environment. When the showerhead 155 is in use, upon exiting the showerhead 155, media may be directed toward a user. In the example of FIG. 8, the showerhead 155 may include thirty-six outlets 190 which may be arranged in a pattern of radial spokes extending between the center point C and various points along the outer boundary 180 of the faceplate 165. Alternatively, the showerhead 155 may include any number of outlets 190, and the outlets 190 may be positioned in any suitable arrangement.

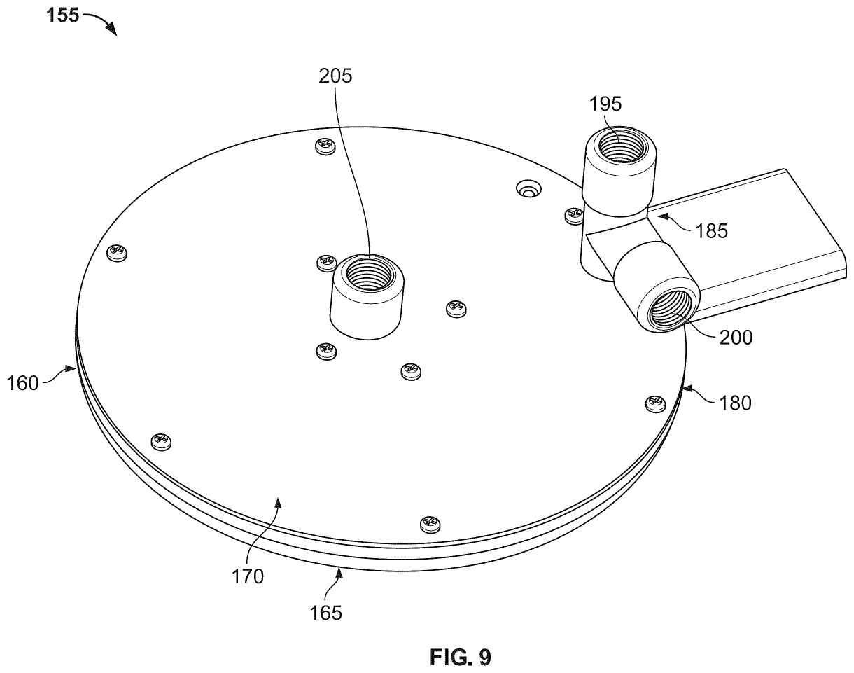

Turning to FIG. 9, the showerhead 155 may include a first inlet 185 positioned proximate to the outer boundary 180 of the backplate 170. The first inlet 185 may be substantially L-shaped and may include at least a first opening 195 and a second opening 200. In the example of FIG. 9, the first opening 195 and the second opening 200 may be oriented substantially perpendicular to one another. However, the first and second openings 195, 200 may be oriented at any other suitable angle with respect to one another. Alternatively, the first inlet 185 may be any other suitable shape and may only include the first opening 195.

The showerhead 155 may also include a second inlet 205. The second inlet 205 may allow for media from an external source to enter the body 160 of the showerhead 155. For example, the media entering via the second inlet 205 may be water, air, heated air, compressed air, hydrogen, ozone, essential oils, scented fluids, shampoo, conditioner, or any other fluid or gas. The external source that feeds the second inlet 205 may be the same external source or a different external source than the external source that feeds the first inlet 185. The second inlet 205 may be positioned at a distance from the outer boundary 180 of the backplate 170. For example, the second inlet 205 may be substantially aligned with the center point C of the faceplate 165.

Various configurations of the first and second inlets 185, 205 are envisioned for providing one or more types of media to the body 160 of the showerhead 155. For example, the first inlet 185 may allow two different types of media to enter the body 160 and media may be prevented from entering the body 160 via the second inlet 205. By way of example, the first opening 195 may receive, be received by, or otherwise be coupled to an external source of water, and the second opening 200 may receive, be received by, or otherwise be coupled to an external source of compressed air. In this configuration, media may enter the body 160 exclusively through the first inlet 185 and the second inlet 205 may be blocked to prevent additional media from unintentionally entering the body 160.

Alternatively, the first inlet 185 may allow a first type of media to enter the body 160, and the second inlet 205 may allow a second type of media to enter the body 160. The first and second types of media entering the body 160 via the first inlet 185 and second inlet 205, respectively, may be the same type of media, or they may be different. By way of example, in this configuration, the first opening 195 of the first inlet 185 may receive, be received by, or otherwise be coupled to an external source of water. The second opening 200 may be blocked to prevent additional media from unintentionally entering the body 160. At the same time, the second inlet 205 may receive, be received by, or otherwise be coupled to an external source of compressed air. In this configuration, the water entering the body 160 via the first inlet 185 and the compressed air entering the body 160 via the second inlet 205 may produce a resonant frequency or standing wave that may result in a “pulsing” behavior of the media that ultimately exits the body 160 and is provided to a user.

In yet other alternatives, the first inlet 185 and second inlet 205 may be provided in any other suitable configuration and may allow for any media to enter the body 160. For example, the first and second openings 195, 200 of the first inlet 185 may both be blocked, and media may be provided to the body 160 exclusively via the second inlet 205. In any configuration in which air enters the body 160 via either the first inlet 185 or the second inlet 205, the air may be compressed air. Configurations that provide multiple types of media to a user may cause the user to perceive the sensation of a stream with higher water pressure without increasing the volume of water supplied to the showerhead 155.

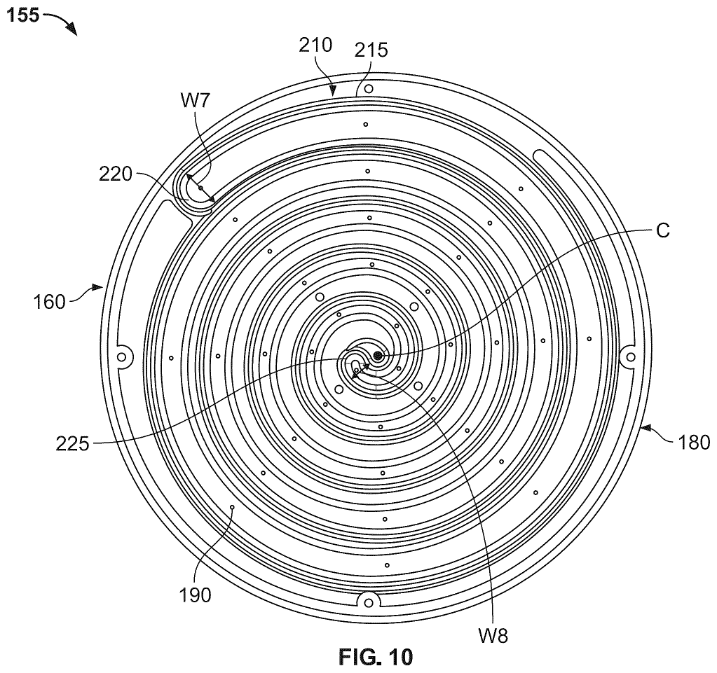

Turning to FIG. 10, the body 160 may house a spiral channel 210 (which may be defined by a sidewall 215). The spiral channel 210 may define a pathway along which media may flow through the showerhead 155. The spiral channel 210 may have a starting end 220 proximate to the outer boundaries 180 and a terminal end 225 proximate to the center point C. Thus, media from one or more inlets 185, the second inlet 205, or combinations thereof may enter the spiral channel 210 at the starting end 220 or proximate to the center point C. The media may travel along the spiral channel 210 as the spiral channel 210 revolves around and approaches closer to the center point C until the media reaches the terminal end 225. The outlets 190 may be positioned on the faceplate 165 to align with the spiral channel 210 such that each outlet 190 forms an opening of the spiral channel 210 to the external environment. As a result, gravity and/or pressure within the spiral channel 210 may cause a portion of the media flowing within the spiral channel 210 to exit via one or more of the outlets 190 before reaching the terminal end 225. When more than one type of media enters the body 160 of the showerhead 155, the multiple types of media may mix within the spiral channel 210 before exiting the body 160 and being directed toward a user.

The spiral channel 210 may have a tapered geometry, which may influence the pressure at which media is provided at each outlet 190. For example, the spiral channel 210 may have a starting width W7, which may be located at the starting end 220, and may have a terminal width W8, which may be located at the terminal end 225. The starting width W7 may be greater than the terminal width W8, and the width of the spiral channel 210 may taper from the starting width W7 to the terminal width W8 along the length of the spiral channel 210.

Likewise, the spiral channel 210 may have a cross-sectional area, which may be defined by a cross-section of the spiral channel 210 taken in a direction that is substantially perpendicular to the faceplate 165 at any point along the length of the spiral channel 210. The cross-sectional area of the spiral channel 210 may decrease as the width of the spiral channel tapers from the starting width W7 to the terminal width W8 along the length of the spiral channel 210. For example, the spiral channel 210 may have a first cross-sectional area at the starting end 220 and a second cross-sectional area at the terminal end 225, and the first cross-sectional area may be greater than the second cross-sectional area.

The tapered geometry of the spiral channel 210 may provide media at a substantially consistent pressure at each outlet 190. For example, narrowing of the spiral channel 210 as water travels from the starting end 220 to the terminal end 225 may increase the localized pressure within the spiral channel 210. The increase in localized pressure due to the geometry of the spiral channel 210 may approximately compensate for the loss in pressure that may result as at least a portion of the volume of media within the spiral channel 210 is lost to the external environment via one or more outlets 190.

The rate of tapering of the width and the cross-sectional area of the spiral channel 210 may or may not be continuous. For example, the rate of tapering from the starting end 220 to the terminal end 225 may be constant. Alternatively, the rate of tapering may be discontinuous and the width and cross-sectional area of the spiral channel 210 may change in “steps.” In yet other alternatives, the rate of tapering may increase or decrease along the length of the spiral channel 210. The specific parameters defining the tapered geometry of the spiral channel 210 may be manipulated or optimized via computer modeling or testing to influence the pressure at which media is provided at each outlet 190. For example, computer modelling may be used to ensure that media is provided at the same pressure at each outlet 190.

In the example of FIG. 10, the width and cross-sectional area of the spiral channel 210 at the starting end 220 may be greater than the width and cross-sectional area of the spiral channel at the terminal end 225. Alternatively, the inverse may be true. For example, the width and cross-sectional area of the spiral channel 210 at the terminal end 225 may be greater than the width and cross-sectional area of the spiral channel 210 at the starting end 220. Additionally, in the example of FIG. 10, the spiral channel 210 is provided in the form of a spiral having a regular or symmetrical shape. However, the spiral channel 210 may be alternatively provided in the form of an irregular spiral, a serpentine shape, an S-shaped pattern, or any other suitable shape or configuration.

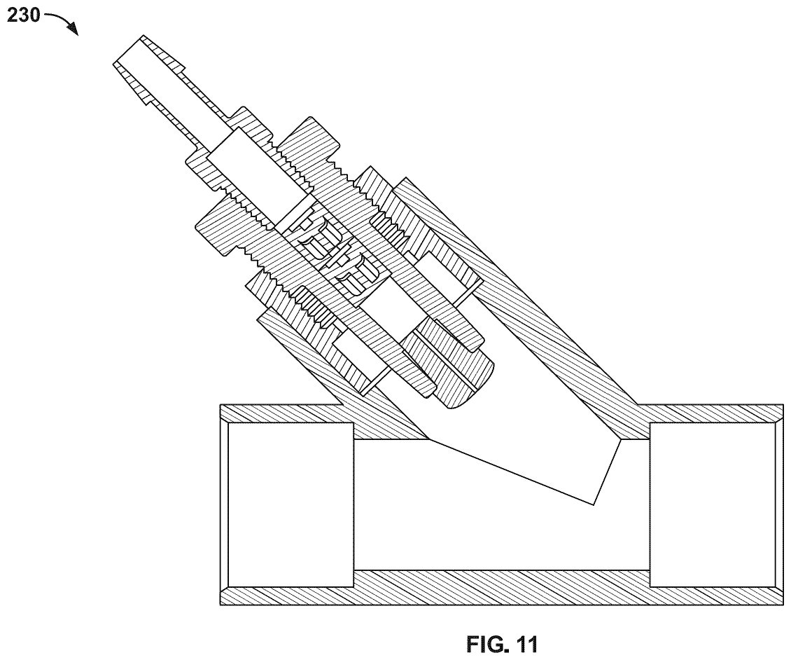

Turning to FIG. 11, a heated conduit 230 may be included in the showerhead 5, the showerhead 155, or other examples of the present invention. The heated conduit 230 may heat media within a showerhead before it is directed toward a user. For example, when the showerhead 5 provides a mixture of water and heated air to a user, the heated conduit 230 may provide the means for warming the air into heated air before directing the heated air toward a user. The heated conduit 230 may facilitate humidification of the heated air by imparting moisture to the air during heating. This humidification may, for example, increase the heat content of the heated air or improve the perceived comfort of a user when being impacted by humidified heated air as opposed to dry heated air.

The heated conduit 230 may be used to heat water or another media, and the heated conduit 230 may heat more than one type of media simultaneously. Further, the heated conduit 230 may heat a mixture containing multiple types of media. For example, the heated conduit 230 may apply heat to a mixture of air and water, rather than heating the air and water separately before they combine to form a mixture. In this way, the heated conduit may impart heat to the mixture with a more even distribution than would be possible if multiple types of media are heated separately before combining to form a mixture. For example, the heated conduit 230 may heat a mixture of multiple types of media without imparting substantially more heat to one portion of the mixture than to another. The improved heat distribution provided by the heated conduit 230 may provide a heated mixture of media to a user without producing a portion of the mixture that may scald or otherwise harm the user. The heated conduit 230 may be substantially similar in structure and function to the conduit assembly described in U.S. Pat. No. 11,331,246 assigned to Kohler Co., the entirety of which is hereby incorporated by reference.

A blow dryer may be integrated into the showerhead 5, the showerhead 155, or other examples of the present invention. The blow dryer may be utilized to assist in drying a user after showering. The blow dryer may output heated air from the showerhead 5 or showerhead 155, which may be directed through the outlets onto the user.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A showerhead comprising:
a plurality of nozzles, wherein each of the plurality of nozzles comprises:
a first chamber defined by a first housing; and
a second chamber defined by the first housing and a second housing;
at least two inlets, wherein a first inlet of the at least two inlets provides a first media to the first chamber, and wherein a second inlet of the at least two inlets provides a second media to the second chamber;
wherein the first media and the second media mix in air after exiting a first outlet of the first chamber and a second outlet of the second chamber, respectively.

2. The showerhead of claim 1, further comprising a partition that divides each of the plurality of nozzles into the first chamber and the second chamber.

3. The showerhead of claim 1, wherein the first chamber is adjustable relative to the second chamber between a first position and a second position.

4. The showerhead of claim 3, wherein when the first chamber is in the first position, the second chamber has a first width, and wherein when the first chamber is in the second position, the second chamber has a second width.

5. The showerhead of claim 4, wherein the first width is less than the second width.

6. The showerhead of claim 3, wherein when the first chamber is in the first position, the second chamber has a first cross-sectional area, and wherein when the first chamber is in the second position, the second chamber has a second cross-sectional area.

7. The showerhead of claim 6, wherein the first cross-sectional area is less than the second cross-sectional area.

8. The showerhead of claim 1, wherein the second chamber is adjustable relative to the first chamber.

9. A showerhead comprising:
a substantially spiral-shaped channel, wherein the channel comprises a first end and a second end, and wherein a first width of the channel proximate to the first end is greater than a second width of the channel proximate to the second end;
at least one inlet for providing a media to the channel; and
a plurality of nozzles aligned along the channel;
wherein a first pressure of media exiting a first nozzle of the plurality of nozzles is substantially equal to a second pressure of media exiting a second nozzle of the plurality of nozzles.

10. The showerhead of claim 9, wherein each of the plurality of nozzles is arranged in a pattern of radial spokes extending between a center point of a body of the showerhead and an outer edge of the body.

11. The showerhead of claim 9, wherein the at least one inlet comprises at least one of:
a first inlet coupled to a first external source of a first media; and
a second inlet coupled to a second external source of a second media;
wherein the first inlet and the second inlet are each in fluid communication with the channel.

12. The showerhead of claim 11, wherein the first media and the second media mix within the channel before being dispensed by the plurality of nozzles.

13. The showerhead of claim 11, wherein the first media is water and the second media is air.

14. The showerhead of claim 11, wherein the first media is air and the second media is water.

15. The showerhead of claim 9, further comprising a heated conduit which heats the media entering the channel.

16. A showerhead comprising:
a plurality of nozzles, wherein each of the plurality of nozzles comprises:
a first chamber; and
a second chamber;
at least two inlets, wherein a first inlet of the at least two inlets provides a first media to the first chamber, and wherein a second inlet of the at least two inlets provides a second media to the second chamber;
wherein the first chamber is adjustable relative to the second chamber between a first position and a second position.

17. The showerhead of claim 16, wherein the first media and the second media mix in air after exiting a first outlet of the first chamber and a second outlet of the second chamber, respectively.

18. The showerhead of claim 16, wherein when the first chamber is in the first position, the second chamber has a first width, and wherein when the first chamber is in the second position, the second chamber has a second width.

19. The showerhead of claim 18, wherein the first width is less than the second width.

20. The showerhead of claim 16, wherein when the first chamber is in the first position, the second chamber has a first cross-sectional area, and wherein when the first chamber is in the second position, the second chamber has a second cross-sectional area, and wherein the first cross-sectional area is less than the second cross-sectional area.
